(19) United States
(12) Patent Application Publication
(10) Pub. No.: US 2023/0315807 A1
(43) Pub. Date: Oct. 5, 2023

(54) SOLUTION SYSTEM, SOLUTION METHOD, AND COMPUTER-READABLE RECORDING MEDIUM

(71) Applicant: NEC Corporation, Minato-ku, Tokyo (JP)

(72) Inventors: Fumiyo TAKANO, Tokyo (JP); Hiroaki INOUE, Tokyo (JP); Takuya ARAKI, Tokyo (JP); Motoi SUZUKI, Tokyo (JP); Yuki KOBAYASHI, Tokyo (JP); Hiroshi CHISHIMA, Tokyo (JP); Akihir YATABE, Tokyo (JP); Takahiro NISHIMURA, Tokyo (JP)

(73) Assignee: NEC Corporation, Minato-ku, Tokyo (JP)

(21) Appl. No.: 18/015,246

(22) PCT Filed: Jul. 17, 2020
(86) PCT No.: PCT/JP2020/027825

§ 371 Date: Jan. 9, 2023

(51) Int. Cl. G06F 17/18

(52) U.S. Cl. CPC G06F 17/18

(57) ABSTRACT

The annealing execution means 73 executes annealing using an energy function, when a solution to a combinatorial optimization problem, and the energy function of a model representing states of individual spins by a first value or a second value which is used to obtain the solution are given, and derives multiple new solutions to the combinatorial optimization problem. The solution determination means 74 determines a solution from among the multiple solutions derived by the annealing execution means 73, based on a solution determination rule for determining a solution among the multiple new solutions and the given solution to the combinatorial optimization problem.

### TECHNICAL FIELD

The present invention relates to a solution system, a solution method, and a computer-readable recording medium in which a solution program is recorded, that obtain a solution to a combinatorial optimization problem.

### BACKGROUND ART

A solution to a combinatorial optimization problem can be obtained by applying an energy function of the Ising model or an energy function of QUBO (Quadratic Unconstrained Binary Optimization), for example, simulated annealing.

The Ising model is a model in statistical mechanics that represents the behavior of a magnetic material by individual spins, and it is also applicable to solving combinatorial optimization problems. In the Ising model, the states of individual spins are represented by “1” or “−1”.

QUBO is also known as a model in which the states of individual spins are represented by “1” or “0”.

Note that “1” in the Ising model and “1” in QUBO can be referred to as the first value, and, “−1” in the Ising model and “0” in QUBO can be referred to as the second value.

The energy function of the Ising model and the energy function of QUBO are mutually convertible.

In the current situation, the solution of the combinatorial optimization problem is obtained by simulated annealing using a general computer mainly with the energy function of the Ising model or of QUBO as input. An example of this method is described below.

First, an expression that represents the energy in the combinatorial optimization problem is generated. The generation of the expression representing energy in the combinatorial optimization problem may be referred to as formulation.

Once the expression representing energy in the combinatorial optimization problem has been generated, the expression is converted to the energy function of the Ising model or the energy function of QUBO. This conversion method is known.

The energy function of the Ising model is expressed as the following Expression (1).

[Math. 1]

H_{Ising}=ΣᵢⱼJᵢⱼxᵢxⱼ+Σᵢhᵢxᵢ (1)

In Expression (1), xᵢ, xⱼ are variables that represent a state of a spin. The subscripts in these variables identify the spins. Jᵢⱼ is a constant related to i and j, and hᵢ is a constant related to i.

The energy function of QUBO is expressed as the following Expression (2).

[Math. 2]

H_{QUBO}=ΣᵢⱼJᵢⱼxᵢxⱼ (2)

In Expression (2), xᵢ, xⱼ are variables that represent a state of a spin. The subscripts in these variables identify the spins. Qᵢⱼ is a constant related to i and j.

Once the energy function of the Ising model or the energy function of QUBO is obtained, the energy function is applied to simulated annealing to specify the state of each spin when the energy is minimized. The state of each spin is then interpreted as the solution to the combinatorial optimization problem.

PTL 1 describes an optimization device that can promote state transitions by allowing transitions to solutions that have energy near the optimal solution and that do not satisfy constraints, and can also suppress the output of solutions that do not satisfy constraints as the optimal solution.

In addition, PTL 2 describes obtaining the difference value between the objective function values of two plans obtained in the process of obtaining a candidate optimal plan.

### CITATION LIST

### Patent Literature

PTL 1: Japanese Patent Application Laid-Open No. 2019-121137

PTL 2: Japanese Patent Application Laid-Open No. H7-141318

### SUMMARY OF INVENTION

### Technical Problem

Hereafter, a person who tries to obtain a solution to a combinatorial optimization problem is referred to as a user.

It is assumed that a solution to a certain combinatorial optimization problem has been obtained. However, a user may wish to change at least part of the solution in response to some change in circumstances. In the following, such a situation is explained. In the following explanation, the work shift creation problem will be used as an example of a combinatorial optimization problem. In this example, it is assumed that an expression representing the energy in the work shift creation problem is created that reflects the constraints of “two or more people should work each day”, “no more than three consecutive work days”, and “no more than two consecutive holidays”, and that the expression is converted into an energy function of QUBO. Moreover, it is assumed that the energy function is then applied to simulated annealing and the solution shown in FIG. 12 is obtained.

In the table shown in FIG. 12, the day of the week is shown horizontally. In the table shown in FIG. 12, A, B, and C in the vertical direction indicate the workers. In the table shown in FIG. 12, each state of the 15 spins from spin 1 to 15 is represented by “1” or “0”. In this example, “1” is assumed to mean that the worker is at work, and “0” is assumed to mean that the worker is not at work.

After the solution shown in FIG. 12 is obtained, there may be a case in which the user wishes to change the solution so that the worker C can take a holiday on Tuesday because the worker C has an urgent business on Tuesday. That is, the user may wish to change the value of spin 12 from “1” to “0”. In this case, it is conceivable that the user does not wish to change the attendance status of other workers as much as possible.

The above example is an example of a case in which the user wishes to change at least part of the solution to a combinatorial optimization problem once obtained, in response to some change in circumstances.

In order to be able to deal with the cases exemplified above, it is desirable to be able to obtain a solution to a combinatorial optimization problem with the desired modifications to already-obtained-solution, when the user wishes to change the already-obtained-solution.

Therefore, an object of the present invention is to provide a solution system, a solution method, and a computer-readable recording medium in which a solution program is recorded, that can obtain a solution to a combinatorial optimization problem with the desired modifications to already-obtained-solution, when the user wishes to change the already-obtained-solution.

### Solution to Problem

A solution system according to the present invention includes: annealing execution means for executing annealing using an energy function, when a solution to a combinatorial optimization problem, and the energy function of a model representing states of individual spins by a first value or a second value which is used to obtain the solution are given, and deriving multiple new solutions to the combinatorial optimization problem, and solution determination means for determining a solution from among the multiple solutions derived by the annealing execution means, based on a solution determination rule for determining a solution among the multiple new solutions and the given solution to the combinatorial optimization problem.

A solution method according to the present invention comprises: executing annealing using an energy function, when a solution to a combinatorial optimization problem, and the energy function of a model representing states of individual spins by a first value or a second value which is used to obtain the solution are given, and deriving multiple new solutions to the combinatorial optimization problem, and determining a solution from among the derived multiple solutions, based on a solution determination rule for determining a solution among the multiple new solutions and the given solution to the combinatorial optimization problem.

A computer-readable recording medium according to the present invention is a computer-readable recording medium in which a solution program is recorded, wherein the solution program causes a computer to execute: an annealing process of executing annealing using an energy function, when a solution to a combinatorial optimization problem, and the energy function of a model representing states of individual spins by a first value or a second value which is used to obtain the solution are given, and deriving multiple new solutions to the combinatorial optimization problem, and a solution determination process of determining a solution from among the multiple solutions derived in the annealing process, based on a solution determination rule for determining a solution among the multiple new solutions and the given solution to the combinatorial optimization problem.

### Advantageous Effects of Invention

According to the present invention, it is able to obtain a solution to a combinatorial optimization problem with the desired modifications to already-obtained-solution, when the user wishes to change the already-obtained-solution.

### BRIEF DESCRIPTION OF DRAWINGS

FIG. 1 It depicts a block diagram showing an example configuration of a solution system of the first example embodiment of the present invention.

FIG. 2 It depicts a schematic diagram showing an example of a newly derived solution to the combinatorial optimization problem.

FIG. 3 It depicts a schematic diagram showing an example of a newly derived solution to the combinatorial optimization problem.

FIG. 4 It depicts a schematic diagram showing an example of a newly derived solution to the combinatorial optimization problem.

FIG. 5 It depicts a flowchart showing an example of the processing flow of the first example embodiment of the present invention.

FIG. 6 It depicts a block diagram showing an example configuration of a solution system of the second example embodiment of the present invention.

FIG. 7 It depicts a flowchart showing an example of the processing flow of the second example embodiment of the present invention.

FIG. 8 It depicts a flowchart showing an example of the processing flow of the second example embodiment of the present invention.

FIG. 9 It depicts a flowchart showing an example of the processing flow of the second example embodiment of the present invention.

FIG. 10 It depicts a schematic block diagram showing an example of computer configuration related to the solution system of each example embodiment of the present invention.

FIG. 11 It depicts a block diagram showing an overview of the solution system of the present invention.

FIG. 12 It depicts a schematic block diagram showing an example of a solution to the combinatorial optimization problem that has already been obtained.

### DESCRIPTION OF EMBODIMENTS

Example embodiments of the present invention are described below with reference to the drawings.

In the following discussion, the case where the energy function of QUBO is applied to annealing to obtain a solution to a combinatorial optimization problem is used. However, the present invention is also applicable to the case where the solution to the combinatorial optimization problem is obtained by applying the energy function of the Ising model to annealing. As already mentioned, “1” in the Ising model and “1” in QUBO can be referred to as the first value. “−1” in the Ising model and “0” in QUBO can be referred to as the second value.

### Example Embodiment 1

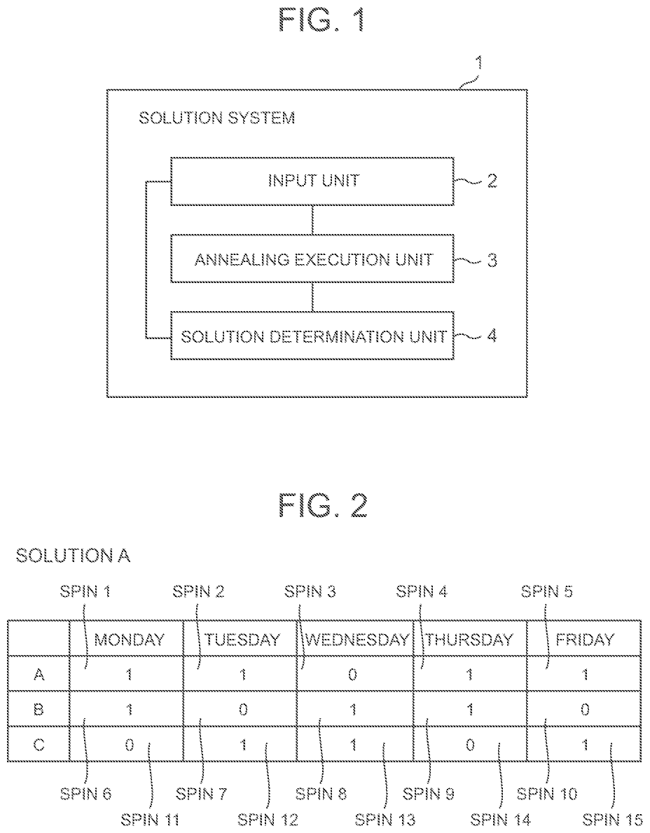

FIG. 1 is a block diagram showing an example configuration of a solution system of the first example embodiment of the present invention. The solution system 1 of the first example embodiment includes an input unit 2, an annealing execution unit 3, and a solution determination unit 4.

A solution to a combinatorial optimization problem already obtained and the energy function of QUBO used in obtaining the solution are input to input unit 2. A solution to a combinatorial optimization problem already obtained and the energy function of the Ising model used in obtaining the solution may also be input to the input unit 2.

In the following explanation, the case in which the solution exemplified in FIG. 12 is input as a solution to a combinatorial optimization problem that has already been obtained is used as an example.

Here, the solution input into the input unit 2 is the solution that the user wishes to change, at least in part.

In addition, a solution determination rule for determining a solution among multiple new solutions is also input to the input unit 2. A solution determination rule is created by a user who wishes to change a solution that has already been obtained, based on the user's wishes. A solution determination rule is a rule for determining a solution from among multiple new solutions with the solution to the combinatorial optimization problem that has already been obtained (the solution input to input unit 2) used as a reference. Thus, the solution determination rule is, for example, “the solution for which the number of spins whose state has been changed from the solution already obtained is the smallest is determined from among multiple solutions”. The solution determination rule may also include information indicating a constraint that the new solution must satisfy. An example of such a constraint is, for example, “the state of spin 12 is ‘0’”, and so on. Thus, as a specific example of a solution determination rule, for example, “the solution for which the state of spin 12 is ‘0’ and the number of spins whose state has been changed from the solution already obtained is the smallest is determined from among multiple solutions”. However, the above solution determination rule is an example, and the solution determination rules is not limited to the above example. For example, the solution determination rule can be defined as follows: “The solution for which the state of spin 12 is ‘0’ and the number of spins for worker A whose state has been changed from the solution already obtained is the smallest is determined from among multiple solutions”. The constraint is not limited to “the state of spin 12 is ‘0’”.

The input unit 2 may be realized by a data reading device that reads data (in the present example embodiment, the solution to the combinatorial optimization problem, the energy function used in obtaining that solution, and the solution determination rule) recorded on a data recording medium such as an optical disk, for example. However, the input unit 2 is not limited to such a data reading device, but may be a keyboard or other input device for the user to input such data. This is also the case in the second example embodiment described below.

The annealing execution unit 3 takes in the energy function of QUBO input to the input unit 2. The solution determination unit 4 takes in the solution (the already obtained solution to the combinatorial optimization problem) and the solution determination rule input to the input unit 2.

The annealing execution unit 3 derives multiple new solutions to the combinatorial optimization problem by executing annealing multiple times using the energy function of QUBO taken in via the input unit 2.

In the first example embodiment, the annealing execution unit 3 may execute simulated annealing or quantum annealing. Both simulated annealing and quantum annealing are stochastic algorithmic processes, and even if the energy function used is invariant, a different solution is obtained each time annealing is executed. Therefore, the annealing execution unit 3 can derive multiple new solutions to the combinatorial optimization problem by executing annealing multiple times using the taken in energy function of QUBO.

The solution determination unit 4 determines a solution from among the multiple new solutions derived by the annealing execution unit 3 based on the solution (the already obtained solution to the combinatorial optimization problem) and the solution determination rule taken in via the input unit 2.

In other words, the solution determination unit 4 determines the solution that best conforms to the solution determination rule from among multiple new solutions with the taken in solution as a reference. In the following explanation, for the sake of simplicity, it is assumed that the solution determination rule is the same as the aforementioned “the solution for which the state of spin 12 is ‘0’ and the number of spins whose state has been changed from the solution already obtained is the smallest is determined from among multiple solutions”. Hereafter, this solution determination rule will be referred to as “solution determination rule R”.

The solution determination unit 4 excludes the solution that does not satisfy the constraint indicated by the solution determination rule from the multiple new solutions. In other words, the solution determination unit 4 selects the solutions that satisfy the constraint indicated by the solution determination rule among the multiple new solutions, and further determines the solution that best conforms to the solution determination rule from among the solutions as the final solution.

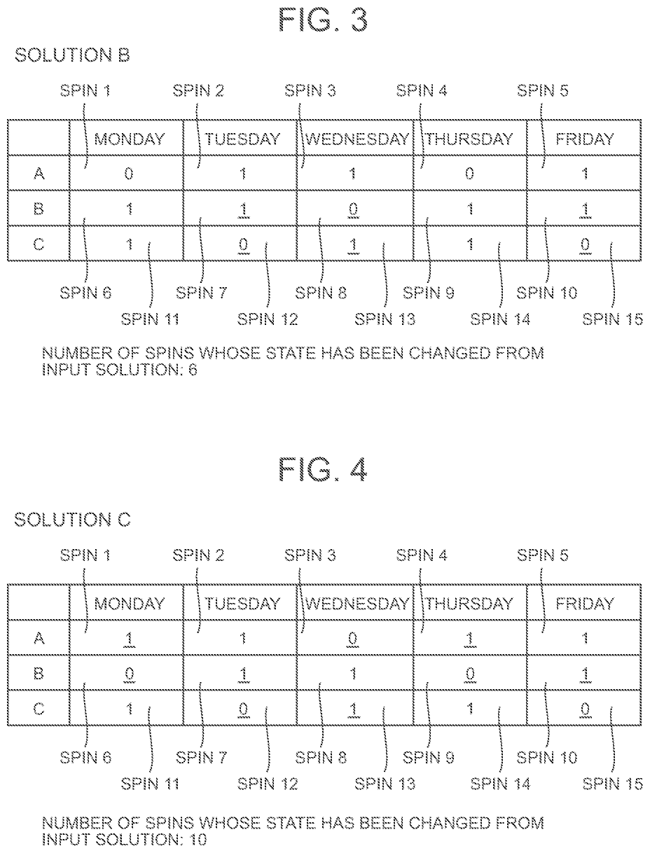

A specific example is shown below. For the sake of simplicity of explanation, the case in which the annealing execution unit 3 executes annealing three times using the taken in energy function and derives three new solutions is used. FIG. 2, FIG. 3, and FIG. 4 are schematic diagrams showing examples of the newly derived solutions, respectively. It is assumed that the annealing execution unit 3 has derived the three solutions illustrated in FIG. 2, FIG. 3, and FIG. 4. The solution shown in FIG. 2 is hereafter referred to as Solution A. The solution shown in FIG. 3 is referred to as Solution B. The solution shown in FIG. 4 is referred to as Solution C. In FIG. 3 and FIG. 4, the states of spin that have been changed from the input solution (see FIG. 12) are underlined.

When solutions A, B, and C are obtained, the solution determination unit 4 excludes the solution that does not satisfy the constraint indicated by the solution determination rule R from the solutions A, B, and C, and selects the solutions that satisfy the constraint. In this example, Solution A has the state “1” in spin 12 (see FIG. 2) and does not satisfy the constraint indicated by the solution determination rule R. In Solution B and C, the state of spin 12 is “0” (see FIG. 3 and FIG. 4), and Solution B and C satisfy the constraint indicated by the solution determination rule R. Therefore, the solution determination unit 4 excludes solution A and selects solutions B and C.

Furthermore, the solution determination unit 4 determines the solution that best conforms to the solution determination rule R from the selected solutions B and C as the final solution. Comparing Solution B with the input solution (see FIG. 12), the number of spins whose state has been changed from the input solution in Solution B is 6. Comparing Solution C with the input solution (see FIG. 12), the number of spins whose state has been changed from the input solution in Solution C is 10. Therefore, the solution determination unit 4 determines that the solution that best conforms to the solution determination rule R is solution B, and determines solution B as the final solution.

In the above example, for simplicity of explanation, the annealing execution unit 3 derives three new solutions, and the solution determination unit 4 determines the final solution from among the three solutions. The number of solutions derived by the annealing execution unit 3 by executing annealing multiple times is not limited to three, and more solutions may be derived.

The annealing execution unit 3 and the solution determination unit 4 are realized, for example, by a CPU (Central Processing Unit) of a computer that operates according to a solution program. In this case, the CPU may read the solution program from a program storage medium such as a program storage device of the computer, and operate as the annealing execution unit 3 and the solution determination unit 4 according to the solution program. When the annealing execution unit 3 executes quantum annealing, the annealing execution unit 3 may be realized by a processor of a quantum computer that operates according to the solution program.

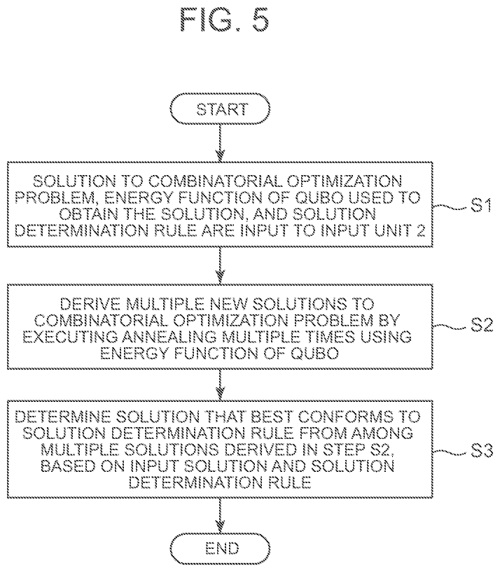

Next, the processing flow will be described. FIG. 5 is a flowchart showing an example of the processing flow of the first example embodiment of the present invention. Matters that have already been explained will be omitted as appropriate.

First, a solution to a combinatorial optimization problem, an energy function of QUBO used to obtain the solution, and a solution determination rule are input to the input unit 2 (step S1). The annealing execution unit 3 takes in the energy function of QUBO. The solution determination unit 4 takes in the input solution to the combinatorial optimization problem and the solution determination rule.

Next, the annealing execution unit 3 derives multiple new solutions to the combinatorial optimization problem by executing annealing multiple times using the taken in energy function of QUBO (step S2). In other words, the annealing execution unit 3 derives multiple new solutions using the energy functions used to derive the already obtained solution (the input solution).

Next, the solution determination unit 4 determines the solution that best conforms to the solution determination rule from among the multiple solutions derived in step S2, based on the input solution and the solution determination rule (step S3).

In the present example embodiment, as described above, the annealing execution unit 3 derives multiple new solutions using the energy function used to derive the already obtained solution (the input solution). The solution determination unit 4 then determines the solution that best conforms to the solution determination rule from among the multiple solutions. Here, the solution determination rule represents the user's wishes as to how the already obtained solution is changed. For example, when the solution determination rule contains the constraint “the state of spin 12 is ‘0”’, the constraint represents the user's wish to put worker C on holiday on Tuesday. Therefore, in the present example embodiment, it is able to obtain a solution to a combinatorial optimization problem with the desired modifications to already-obtained-solution, when the user wishes to change the already-obtained-solution.

### Example Embodiment 2

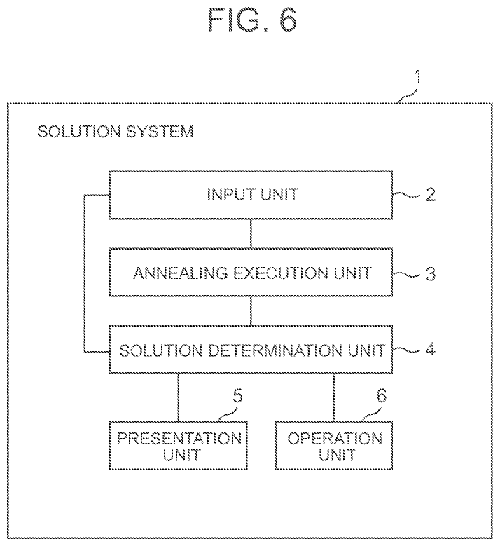

FIG. 6 is a block diagram showing an example configuration of a solution system of the second example embodiment of the present invention. The solution system 1 of the second example embodiment includes an input unit 2, an annealing execution unit 3, a solution determination unit 4, a presentation unit 5, and an operation unit 6.

A solution to a combinatorial optimization problem already obtained, an energy function of QUBO used in obtaining the solution, and a solution determination rule are input to the input unit 2. As described in the first example embodiment, a solution to a combinatorial optimization problem already obtained and the energy function of the Ising model used in obtaining the solution may also be input. The solution determination rule is the same as the solution determination rule in the first example embodiment.

In the second example embodiment, the energy value of the solution to the combinatorial optimization problem already obtained (in other words, the input solution) is also input to the input unit 2. This energy value can be calculated by substituting the values representing the individual states of spins indicated by the solution to the combinatorial optimization problem already obtained into the energy function of QUBO used to obtain the solution.

The annealing execution unit 3 takes in the energy function of QUBO, the energy value of the solution of the combinatorial optimization problem already obtained, and the solution determination rule input to the input unit 2. The solution determination unit 4 takes in the solution (the solution of the combinatorial optimization problem already obtained) and the solution determination rule input to the input unit 2.

The annealing execution unit 3 may calculate the energy value of the solution of the combinatorial optimization problem that has already been obtained. In this case, the annealing execution unit 3 takes in the solution of the combinatorial optimization problem already obtained along with the energy function of QUBO. Then, the annealing execution unit 3 may calculate the energy value of the solution by substituting the values representing the individual states of spins indicated by the solution into the energy function.

Here, the case in which the energy value of the solution to the combinatorial optimization problem that has already been obtained is input to the input unit 2 is used. Hereafter, the energy value of the solution to the combinatorial optimization problem that has already been obtained is referred to as energy value H.

In the second example embodiment, the annealing execution unit 3 executes simulated annealing using the taken in energy function.

In simulated annealing, various states of each spin are obtained as the on-going status. In the present example embodiment, the annealing execution unit 3 executes one simulated annealing using the taken in energy function, and defines the state of each spin obtained as the on-going status of the annealing, whose energy value is lower than the energy value H (the energy value of the solution of the combinatorial optimization problem that has already been obtained) as a solution candidate. Therefore, even if simulated annealing is executed once, multiple solution candidates are obtained.

The solution determination unit 4 determines the first solution candidate obtained by the annealing execution unit 3 to be the provisional solution. Thereafter, when a new solution candidate is obtained by the annealing execution unit 3, the solution determination unit 4 determines which of the new solution candidate and the provisional solution conforms better to the solution determination rule, and when the new solution candidate conforms to the solution determination rule better than the provisional solution, the solution determination unit 4 repeats updating the provisional solution with the new solution candidate.

When determining whether the new solution candidate or the provisional solution better conforms to the solution determination rule, the solution determination unit 4 refers to the input solution (the solution to the combinatorial optimization problem already obtained) to determine whether the new solution candidate or the provisional solution better conforms to the solution determination rule.

Then, the solution determination unit 4 determines the provisional solution at the point in time when the iterative process, as described above, to update the provisional solution is stopped, as the final solution.

The presentation unit 5 presents the provisional solution to the user each time a new provisional solution is determined. The operation unit 6 is an input device (e.g., keyboard) for the user to input instructions to stop the iterative process to update the provisional solution. The presentation unit 5 presents the provisional solution to the user each time a new provisional solution is determined, and when the user who looks at the provisional solution judges that the provisional solution is acceptable as the final solution, the user may input the instruction to stop the iterative process to update the provisional solution via the operation unit 6. When the solution determination unit 4 receives this instruction to stop, the solution determination unit 4 stops the iterative process to update the provisional solution and determines the provisional solution at that point in time as the final solution. When this instruction to stop is not input, the iterative process to update the provisional solution is continued.

The manner in which the iterative process to update the provisional solution is stopped is not limited to the above.

The presentation unit 5 presents the provisional solution to the user by, for example, displaying the provisional solution on a display device (not shown) provided by the solution system 1.

The annealing execution unit 3, the solution determination unit 4, and the presentation unit are realized by a CPU of a computer that operates according to a solution program. In this case, the CPU may read the solution program from a program storage medium such as a program storage device of the computer, and operate as the annealing execution unit 3, the solution determination unit 4, and the presentation unit 5 according to the solution program.

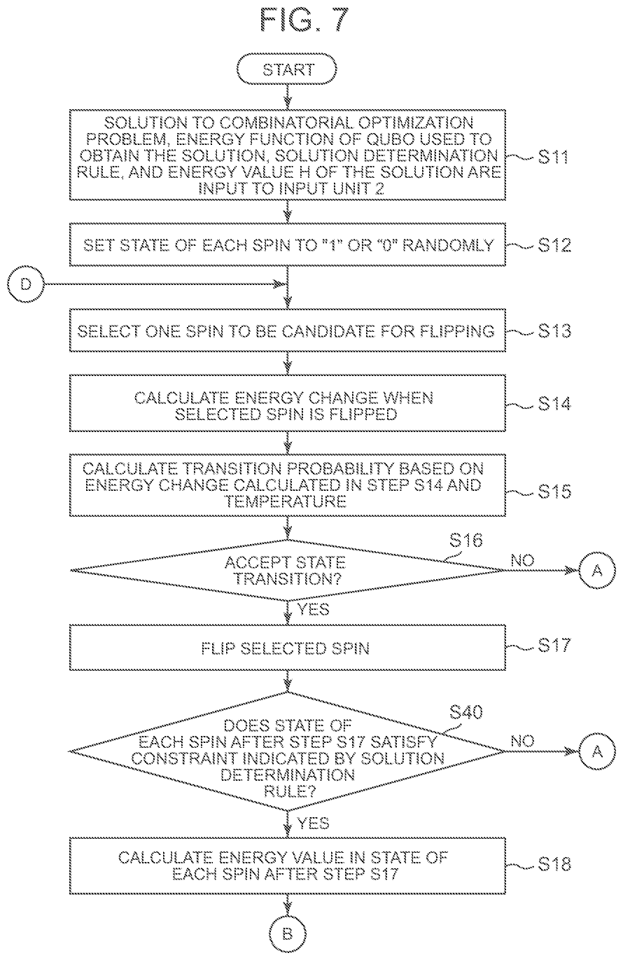

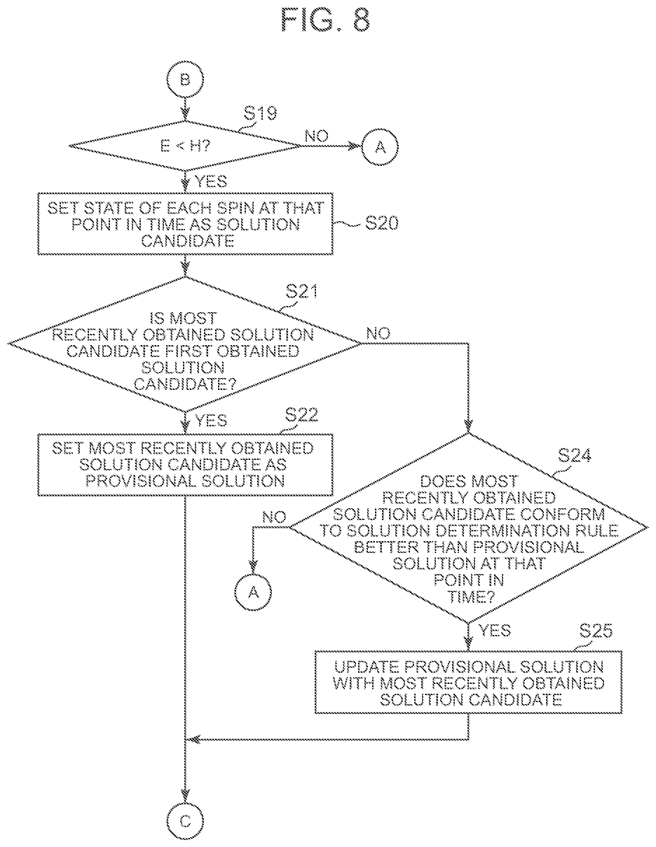

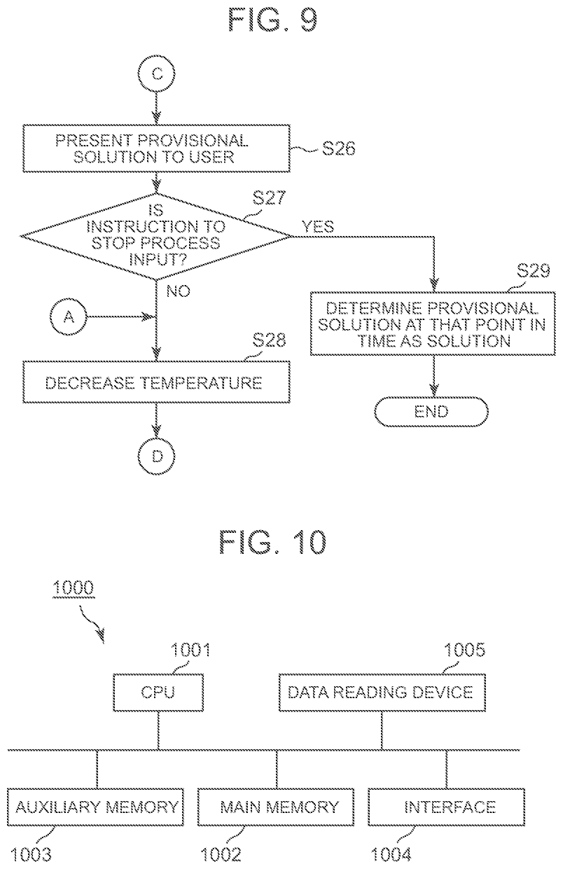

Next, the processing flow will be described. FIG. 7, FIG. 8, and FIG. 9 are flowcharts showing an example of the processing flow of the second example embodiment of the present invention. Matters that have already been explained will be omitted as appropriate.

It is assumed that the temperature in simulated annealing is set to the initial value.

First, a solution to a combinatorial optimization problem, an energy function of QUBO used to obtain the solution, a solution determination rule, and the energy value H of the solution are input to the input unit 2 (step S11). The annealing execution unit 3 takes in the energy function of QUBO, the energy value H, and the solution determination rule. The solution determination unit 4 takes in the input solution of the combinatorial optimization problem and the solution determination rule.

Next, the annealing execution unit 3 randomly sets the state of each spin to “1” or “0” (Step S12).

Next, the annealing execution unit 3 selects one spin to be a candidate for flipping (step S13). Note that “flipping” means changing the state of spin. The spin selected in step S13 is hereinafter referred to as the selected spin.

Next, the annealing execution unit 3 calculates the energy change when the selected spin is flipped (step S14).

Next, the annealing execution unit 3 calculates the transition probability based on the energy change calculated in step S14 and the temperature in simulated annealing (step S15).

Next, the annealing execution unit 3 determines whether to accept or reject the state transition based on the transition probability calculated in step S15 (step S16).

When the state transition is accepted (Yes in step S16), the annealing execution unit 3 flips the selected spin (Step S17). When the state transition is not accepted (No in step S16), the process moves to step S28 (see FIG. 9), and in step S28, the annealing execution unit 3 decreases the temperature in simulated annealing.

Next to step S17, the annealing execution unit 3 determines whether or not the state of each spin after step S17 (i.e. the state of each spin after flipping the selected spin) satisfies the constraint indicated by the solution determination rule (step S40). When the state of each spin after step S17 does not satisfy the constraint indicated by the solution determination rule (No in step S40), the process moves to step S28 (see FIG. 9), and in step S28, the annealing execution unit 3 decreases the temperature in simulated annealing.

When the state of each spin after step S17 satisfies the constraint indicated by the solution determination rule (Yes in step S40), the annealing execution unit 3 calculates the energy value in the state of each spin after step S17 using the energy function (step S18). The energy value calculated in step S18 is referred to as energy value E. The energy value E can be said to be the energy value in the state of each spin at that point in time.

Next, the annealing execution unit 3 determines whether or not the energy value E in the state of each spin at that point in time is lower than the input energy value H (step S19). Step S19 and thereafter are shown in FIG. 8.

When the energy value E is greater than or equal to the energy value H (No in step S19), the process moves to step S28 (see FIG. 9), and in step S28, the annealing execution unit 3 decreases the temperature in simulated annealing.

Also, when the energy value E is less than the energy value H (Yes in step S19), the state of each spin at that point in time (the state of each spin after flipping the selected spins in step S17) is set as the solution candidate (step S20).

Next to step S20, the solution determination unit 4 determines whether or not the most recently obtained solution candidate (i.e., the solution candidate obtained in the previous step S20) is the first obtained solution candidate (step S21).

When the most recently obtained solution candidate is the first obtained solution candidate (Yes in step S21), the solution determination unit 4 sets the most recently obtained solution candidate (i.e., the first obtained solution candidate) as the provisional solution (step S22). In step S22, the provisional solution is determined for the first time.

After step S22, the process moves to step S26 (see FIG. 9). Step S26 and thereafter are shown in FIG. 9.

When the most recently obtained solution candidate is not the first obtained solution candidate (No in step S21), a provisional solution has already been determined. In this case, the solution determination unit 4 determines whether or not the most recently obtained solution candidate conforms to the solution determination rule better than the provisional solution at that point in time (step S24). In this case, the solution determination unit 4 determines whether or not the most recently obtained solution candidate conforms to the solution determination rule better than the provisional solution at that point in time by referring to the input solution (the solution to the combinatorial optimization problem that has already been obtained).

When the provisional solution at that point in time conforms to the solution determination rule better than the most recently obtained solution candidate (No in step S24), the process moves to step S28 (see FIG. 9), and in step S28, the annealing execution unit 3 decreases the temperature in simulated annealing.

When the most recently obtained solution candidate conforms to the solution determination rule better than the provisional solution at that point in time (Yes in step S24), then the solution determination unit 4 updates the provisional solution at that point in time with the most recently obtained solution candidate (step S25). In other words, the most recently obtained solution candidate becomes the new provisional solution.

After step S25, the process moves to step S26 (see FIG. 9).

In both step S22 and step S25, a new provisional solution is determined. After the new provisional solution is determined, the process moves to step S26 (see FIG. 9).

In step S26 (see FIG. 9), the presentation unit 5 presents the provisional solution at that point in time (in other words, the newly determined provisional solution) to the user.

The user can look at the provisional solution and decide whether or not the provisional solution is acceptable as the final solution. When the user decides not to use the provisional solution as the final solution, the user does not input an instruction to stop the process. When the user decides that the provisional solution should be the final solution, the user inputs an instruction to stop the process via the operation unit 6.

When, after step S26, the user does not input an instruction to stop the process (No in step S27), the annealing execution unit 3 decreases the temperature in simulated annealing (step S28).

After step S28, the solution system 1 repeats the process after step S13 (see FIG. 7). Thus, the iterative process starting from step S13 is repeated.

When, after step S26, the user inputs an instruction to stop the process (Yes in step S27), the solution determination unit 4 determines the provisional solution at that point in time as the final solution (step S29) and the process is terminated.

As can be seen from the above explanation with the flowchart, in the second example embodiment, the iterative process starting from step S13 is repeated. Then, in step S24, the solution determination unit 4 determines whether or not the most recently obtained solution candidate conforms to the solution determination rule better than the provisional solution at that point in time. When the most recently obtained solution candidate conforms to the solution determination rule better than the provisional solution at that point in time (Yes in Step S24), the solution determination unit 4 updates the provisional solution at that point in time with the most recently obtained solution candidate (step S25). Thus, as the iterative process is repeated, the provisional solution is updated to conform to the solution determination rule better. When the user decides that the provisional solution is to be the final solution, the iterative process is stopped according to the user's instruction, and the provisional solution at that point is determined as the final solution. In addition, the state of each spin that does not satisfy the constraint of the solution determination rule is not determined as a solution candidate (see step S40). Thus, a solution that conforms to the user's wishes is obtained. Thus, in the present example embodiment, it is able to obtain a solution to a combinatorial optimization problem with the desired modifications to already-obtained-solution, when the user wishes to change the already-obtained-solution.

FIG. 10 is a schematic block diagram showing an example of computer configuration related to the solution system 1 of each example embodiment of the present invention. The computer 1000 includes a CPU 1001, a main memory 1002, an auxiliary memory 1003, an interface 1004, and a data reading device 1005. The computer 1000 may also include an input device such as a keyboard and a display device.

The solution system 1 of each example embodiment of the present invention, is realized by the computer 1000. The operation of the solution system 1 is stored in the auxiliary memory 1003 in the form of a solution program. The CPU 1001 reads the solution program from the auxiliary memory 1003, expands the solution program in the main memory 1002, and executes the process described in each of the above example embodiments according to the solution program.

The auxiliary memory 1003 is an example of a non-transitory tangible medium. Other examples of non-transitory tangible media include magnetic disks connected via interface 1004, magneto-optical disks, CD-ROM (Compact Disk Read Only Memory), DVD-ROM (Digital Versatile Disk Read Only Memory), semiconductor memory, etc. When the program is delivered to the computer 1000 through a communication line, the computer 1000 may expand the program in the main memory 1002 and execute the process described in each of the above example embodiments.

Some or all of the components may be realized by general-purpose or dedicated circuitry, processor, or a combination of these. These may comprise a single chip or multiple chips connected via a bus. Some or all of the components may be realized by a combination of the above-mentioned circuitry, etc. and a program.

When some or all of components is realized by multiple information processing devices, circuits, etc., the multiple information processing devices, circuits, etc. may be centrally located or distributed. For example, the information processing devices and circuits may be realized as a client-and-server system, a cloud computing system, etc., each of which is connected via a communication network.

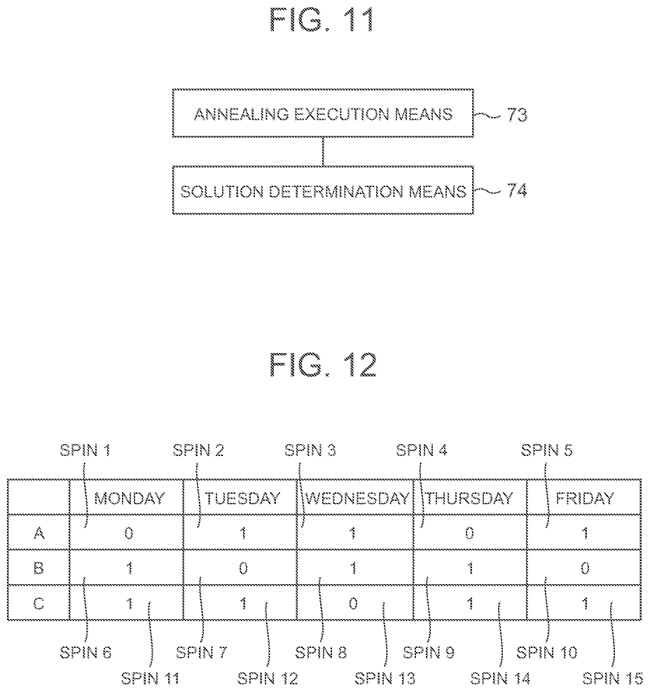

Next, an overview of the present invention is described. FIG. 11 is a block diagram showing an overview of the solution system of the present invention. The solution system of the present invention includes annealing execution means 73 and solution determination means 74.

The annealing execution means 73 (e.g., the annealing execution unit 3) executes annealing using an energy function, when a solution to a combinatorial optimization problem, and the energy function of a model representing states of individual spins by a first value or a second value (e.g., the Ising model or QUBO) which is used to obtain the solution are given, and derives multiple new solutions to the combinatorial optimization problem.

The solution determination means 74 (e.g., the solution determination unit 4) determines a solution from among the multiple solutions derived by the annealing execution means 73, based on a solution determination rule for determining a solution among the multiple new solutions and the given solution to the combinatorial optimization problem.

According to such a configuration, it is able to obtain a solution to a combinatorial optimization problem with the desired modifications to already-obtained-solution, when the user wishes to change the already-obtained-solution.

The example embodiments of the present invention described above may also be described as in the following supplementary notes, but are not limited to the following supplementary notes.

(Supplementary note 1)

A solution system comprising:
annealing execution means for executing annealing using an energy function, when a solution to a combinatorial optimization problem, and the energy function of a model representing states of individual spins by a first value or a second value which is used to obtain the solution are given, and deriving multiple new solutions to the combinatorial optimization problem, and
solution determination means for determining a solution from among the multiple solutions derived by the annealing execution means, based on a solution determination rule for determining a solution among the multiple new solutions and the given solution to the combinatorial optimization problem.

(Supplementary note 2)

The solution system according to supplementary note 1,
wherein the annealing execution means
derives the multiple new solutions by executing annealing multiple times using the energy function.

(Supplementary note 3)

The solution system according to supplementary note 1,
wherein the annealing execution means
executes simulated annealing using the energy function, and
defines state of each spin obtained as on-going status of the simulated annealing, whose energy value is lower than an energy value of the given solution to the combinatorial optimization problem as a solution candidate,
the solution determination means
determines the solution candidate obtained first to be a provisional solution,
repeats determining which of a new solution candidate and the provisional solution conforms better to the solution determination rule when the new solution candidate is obtained, and updating the provisional solution with the new solution candidate when the new solution candidate conforms to the solution determination rule better than the provisional solution, and
determines the provisional solution at the point in time when an iterative process to update the provisional solution is stopped, as the solution.

(Supplementary note 4)

The solution system according to supplementary note 3, comprising:
presentation means for presenting the provisional solution to a user each time a new provisional solution is obtained,
wherein the solution determination means,
when an instruction to stop the iterative process to update the provisional solution is input by a user, stops the iterative process, and determines the provisional solution at the point in time as the solution.

(Supplementary note 5)

The solution system according to any one of supplementary notes 1 to 4,
wherein the solution determination rule includes information indicating a constraint that the solution must satisfy.

(Supplementary note 6)

A solution method comprising:
executing annealing using an energy function, when a solution to a combinatorial optimization problem, and the energy function of a model representing states of individual spins by a first value or a second value which is used to obtain the solution are given, and deriving multiple new solutions to the combinatorial optimization problem, and
determining a solution from among the derived multiple solutions, based on a solution determination rule for determining a solution among the multiple new solutions and the given solution to the combinatorial optimization problem.

(Supplementary note 7)

The solution method according supplementary note 6, comprising:
deriving the multiple new solutions by executing annealing multiple times using the energy function.

(Supplementary note 8)

The solution method according supplementary note 6, comprising:
executing simulated annealing using the energy function,
defining state of each spin obtained as on-going status of the simulated annealing, whose energy value is lower than an energy value of the given solution to the combinatorial optimization problem as a solution candidate,
determining the solution candidate obtained first to be a provisional solution,
repeating determining which of a new solution candidate and the provisional solution conforms better to the solution determination rule when the new solution candidate is obtained, and updating the provisional solution with the new solution candidate when the new solution candidate conforms to the solution determination rule better than the provisional solution, and
determining the provisional solution at the point in time when an iterative process to update the provisional solution is stopped, as the solution.

(Supplementary note 9)

A computer-readable recording medium in which a solution program is recorded, wherein the solution program causes a computer to execute:

an annealing process of executing annealing using an energy function, when a solution to a combinatorial optimization problem, and the energy function of a model representing states of individual spins by a first value or a second value which is used to obtain the solution are given, and deriving multiple new solutions to the combinatorial optimization problem, and
a solution determination process of determining a solution from among the multiple solutions derived in the annealing process, based on a solution determination rule for determining a solution among the multiple new solutions and the given solution to the combinatorial optimization problem.

(Supplementary note 10)

The computer-readable recording medium in which the solution program is recorded, according to supplementary note 9,
wherein the solution program causes a computer to execute:
in the annealing process,
deriving the multiple new solutions by executing annealing multiple times using the energy function.

(Supplementary note 11)

The computer-readable recording medium in which the solution program is recorded, according to supplementary note 9,
wherein the solution program causes a computer to execute:
in the annealing process,
executing simulated annealing using the energy function, and
defining state of each spin obtained as on-going status of the simulated annealing, whose energy value is lower than an energy value of the given solution to the combinatorial optimization problem as a solution candidate,
in the solution determination process,
determining the solution candidate obtained first to be a provisional solution,
repeating determining which of a new solution candidate and the provisional solution conforms better to the solution determination rule when the new solution candidate is obtained, and updating the provisional solution with the new solution candidate when the new solution candidate conforms to the solution determination rule better than the provisional solution, and
determining the provisional solution at the point in time when an iterative process to update the provisional solution is stopped, as the solution.

Although the present invention has been described above with reference to the example embodiments, the present invention is not limited to the above example embodiments. Various changes can be made to the configuration and details of the present invention that can be understood by those skilled in the art within the scope of the present invention.

### INDUSTRIAL APPLICABILITY

The invention is suitably applied to a solution system for obtaining a solution to a combinatorial optimization problem.

### REFERENCE SIGNS LIST

1 Solution system
2 Input unit
3 Annealing execution unit
4 Solution determination unit
5 Presentation unit
6 Operation unit

What is claimed is:

1. A solution system comprising:
a memory configured to store instructions; and
a processor configured to execute the instructions to:
execute annealing using an energy function, when a solution to a combinatorial optimization problem, and the energy function of a model representing states of individual spins by a first value or a second value which is used to obtain the solution are given, and derive multiple new solutions to the combinatorial optimization problem, and
determine a solution from among the multiple solutions derived by the processor, based on a solution determination rule for determining a solution among the multiple new solutions and the given solution to the combinatorial optimization problem.

2. The solution system according to claim 1,
wherein the processor
derives the multiple new solutions by executing annealing multiple times using the energy function.

3. The solution system according to claim 1,
wherein the processor
executes simulated annealing using the energy function, and
defines state of each spin obtained as on-going status of the simulated annealing, whose energy value is lower than an energy value of the given solution to the combinatorial optimization problem as a solution candidate,
the processor
determines the solution candidate obtained first to be a provisional solution,
repeats determining which of a new solution candidate and the provisional solution conforms better to the solution determination rule when the new solution candidate is obtained, and updating the provisional solution with the new solution candidate when the new solution candidate conforms to the solution determination rule better than the provisional solution, and
determines the provisional solution at the point in time when an iterative process to update the provisional solution is stopped, as the solution.

4. The solution system according to claim 3,
wherein the processor presents the provisional solution to a user each time a new provisional solution is obtained,
wherein the processor,
when an instruction to stop the iterative process to update the provisional solution is input by a user, stops the iterative process, and determines the provisional solution at the point in time as the solution.

5. The solution system according to claim 1,
wherein the solution determination rule includes information indicating a constraint that the solution must satisfy.

6. A solution method comprising:
executing annealing using an energy function, when a solution to a combinatorial optimization problem, and the energy function of a model representing states of individual spins by a first value or a second value which is used to obtain the solution are given, and deriving multiple new solutions to the combinatorial optimization problem, and
determining a solution from among the derived multiple solutions, based on a solution determination rule for determining a solution among the multiple new solutions and the given solution to the combinatorial optimization problem.

7. The solution method according claim 6, comprising:
deriving the multiple new solutions by executing annealing multiple times using the energy function.

8. The solution method according claim 6, comprising:
executing simulated annealing using the energy function,
defining state of each spin obtained as on-going status of the simulated annealing, whose energy value is lower than an energy value of the given solution to the combinatorial optimization problem as a solution candidate,
determining the solution candidate obtained first to be a provisional solution,
repeating determining which of a new solution candidate and the provisional solution conforms better to the solution determination rule when the new solution candidate is obtained, and updating the provisional solution with the new solution candidate when the new solution candidate conforms to the solution determination rule better than the provisional solution, and
determining the provisional solution at the point in time when an iterative process to update the provisional solution is stopped, as the solution.

9. A non-transitory computer-readable recording medium in which a solution program is recorded, wherein the solution program causes a computer to execute:
an annealing process of executing annealing using an energy function, when a solution to a combinatorial optimization problem, and the energy function of a model representing states of individual spins by a first value or a second value which is used to obtain the solution are given, and deriving multiple new solutions to the combinatorial optimization problem, and
a solution determination process of determining a solution from among the multiple solutions derived in the annealing process, based on a solution determination rule for determining a solution among the multiple new solutions and the given solution to the combinatorial optimization problem.

10. The non-transitory computer-readable recording medium in which the solution program is recorded, according to claim 9,
wherein the solution program causes a computer to execute:
in the annealing process,
deriving the multiple new solutions by executing annealing multiple times using the energy function.

11. The non-transitory computer-readable recording medium in which the solution program is recorded, according to claim 9,
wherein the solution program causes a computer to execute:
in the annealing process,
executing simulated annealing using the energy function, and
defining state of each spin obtained as on-going status of the simulated annealing, whose energy value is lower than an energy value of the given solution to the combinatorial optimization problem as a solution candidate,
in the solution determination process,
determining the solution candidate obtained first to be a provisional solution,
repeating determining which of a new solution candidate and the provisional solution conforms better to the solution determination rule when the new solution candidate is obtained, and updating the provisional solution with the new solution candidate when the new solution candidate conforms to the solution determination rule better than the provisional solution, and
determining the provisional solution at the point in time when an iterative process to update the provisional solution is stopped, as the solution.
